(19) United States
(12) Patent Application Publication
(10) Pub. No.: US 2020/0223341 A1
(43) Pub. Date: Jul. 16, 2020

(54) HEADREST AND HEADREST SYSTEM

(71) Applicants: Manuel BOESL, Freudenberg (DE); Marco REDWITZ, Barbing (DE)

(72) Inventors: Manuel BOESL, Freudenberg (DE); Marco REDWITZ, Barbing (DE)

(21) Appl. No.: 16/739,435

(22) Filed: Jan. 10, 2020

(30) Foreign Application Priority Data
Jan. 11, 2019 (DE) 102019000120.6

(51) Int. Cl. B60N 2/879; B60R 11/02; G03B 21/56; H04N 9/31

(52) U.S. Cl. CPC B60N 2/879; B60R 11/0235; B60R 2011/0082; H04N 9/3147; G03B 21/56

(57) ABSTRACT

The invention relates inter alia to a headrest (12) for a vehicle seat (11) comprising a head contact part (21) that can be supported on the vehicle seat (11) by a mount or that is formed integrally with a part of the vehicle seat (11), the head contact part (21) has at least one projection system (26) that has at least one projector (19a, 19b) that can be connected to a power supply of the vehicle, and that can project a beam, such as light information, onto a projection surface (22, 24).

The invention relates to a headrest for a vehicle seat.

It is known from the prior art to arrange lights in the vehicle passenger compartment, which lights are fastened for example on the roof liner and either shine diffusely into the entire passenger compartment or are focused on a specific region, in a manner functioning as a reading light. Said lights allow only for illumination of objects or the vehicle passenger compartment.

The object of the invention was that of developing a headrest that can display information, in addition to simple illumination.

The object was achieved by a headrest having the features of claim 1.

The headrest comprises a head contact part that can be supported on a vehicle seat by a mount, or is formed integrally with a part of the vehicle seat. The head contact part has at least one projection system that has at least one projector that can be connected to a power supply of the vehicle. Information can be projected onto a projection surface or issued in a projection region by the projector, e.g. in accordance with what is known as beamer.

In this case, the projector for example transmits information by light beams or radiation, which information is displayed on a projection surface in a projection region, such as the surface of a wall, smoke or mist, as a result of reflection. Alternatively, the projector transmits radiation or a beam, such as a laser beam, which generates a two- or three-dimensional hologram in a project region, which hologram can be perceived by the vehicle occupants. The hologram does not always require a projection surface within the meaning of a reflection surface. The beam can generate a self-luminous image for example as a result of the plasmarization of the air molecules.

It is not necessary, in all cases, for the projection surface to be planar. When transmitting projections, however, this is advantageous. In the case of simple information, such as warning messages, a non-planar projection surface may be sufficient.

It is advantageous to provide the projector in the headrest, because the projection direction corresponds to the orientation and the viewing region of the seat occupant, and because the device can be arranged in the headrest in a space-saving manner at least in part. In this manner, the seat occupant can perceive information without changing their sitting position.

The projector can be oriented on the head contact part for example such that the beam of the projector strikes a projection surface or in a projection region of the vehicle passenger compartment. A projection surface can be formed for example by a window, dashboard, vehicle seat, vehicle roof lining, smoke or mist.

If the projector generates a self-luminous hologram by a beam, said hologram can be generated at any desired suitable point in a projection region of the passenger compartment. A reflection surface is then not required.

The projection system has for example a controller that controls the projector depending on a signal of a specified beam state, such as a constant beam, an interval beam, or different beam colors. In this way, it is possible to communicate information, signals or images to the seat occupant or other occupants of the vehicle passenger compartment, by the projection system. This information can be of a general nature, for example, or can related to the vehicle or the travel situation.

For example, the projection system has a sensor that is connected to the controller for transmitting a signal thereto. The sensor can gather particular information and forward this to the controller, which actuates a particular illumination state on the projector unit depending on the signal of the sensor. For example, the distance from the vehicle travelling in front of the vehicle in question can be gathered by the sensor and forwarded to the controller. If a minimum spacing is not met, the controller can actuate the projector such that a signal, for example in the form of a particular color or a flickering light, can be transmitted from the projector and displayed at another point in the vehicle passenger compartment.

The projection system can be connectable for example to a computer, for example a vehicle computer, and an image generated by the computer is then emitted by the projector and displayed at another point. The projector can for example display a navigation program, for example on the projection surface.

For example, the controller can also be manually actuated, such that the projector can be turned on and off as a simple reading light.

The invention also relates to a headrest system comprising a headrest according to the first aspect of the invention, and comprising a projection surface that is formed at a suitable point in the vehicle passenger compartment. Simple information can be displayed on almost every kind of projection surface. In the case of detailed information, it is advantageous for a projection surface to be provided in the vehicle that allows for detailed information to be displayed. Said surface can for example be a stationary suitable surface that is arranged for example in the dashboard or at another point in the vehicle, or alternatively a surface that is activated only in the event of operation of the projector.

For example, the projection surface is associated with a deploying device that moves the projection wall between a stowage position and a stretched position. This is advantageous in that, when the projector is not in use, the projection wall does not occupy any space in the vehicle, and during operation of the projector improved display is possible.

For example billows or smoke or wafts of mist generated by a device are also suitable as a projection surface.

Each projector is associated for example with a separate projection surface. Alternatively, a plurality of projectors is associated with one projection surface.

The projection surface is for example transparent. In this case, other information, behind the projection surface, can also be perceived by the occupants, in addition to the information transmitted by the projector.

Further advantages can be seen from an exemplary embodiment shown in the figures. In said figures:

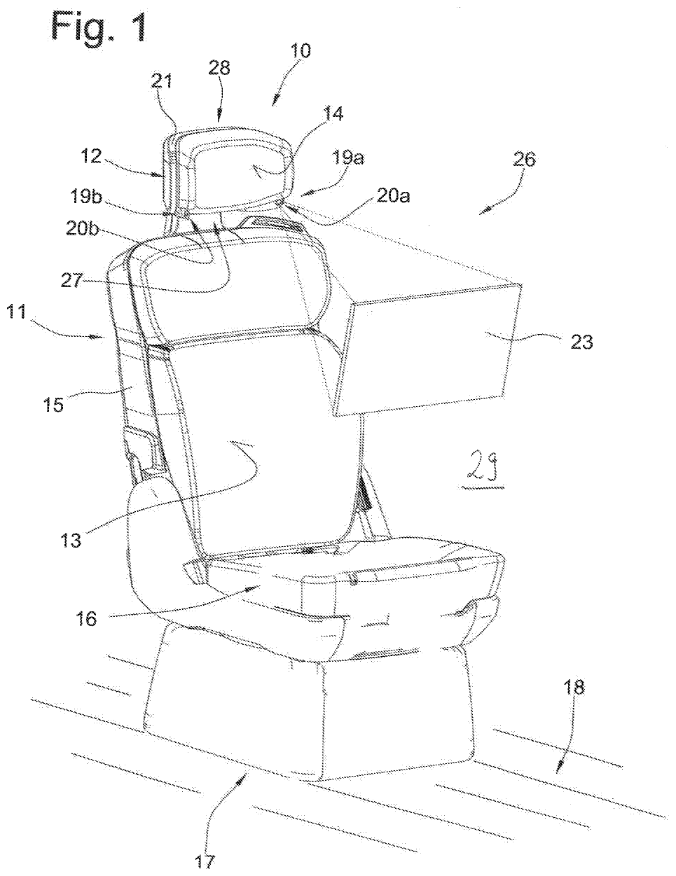

FIG. 1 is a perspective view of a vehicle seat including a headrest system according to the invention,

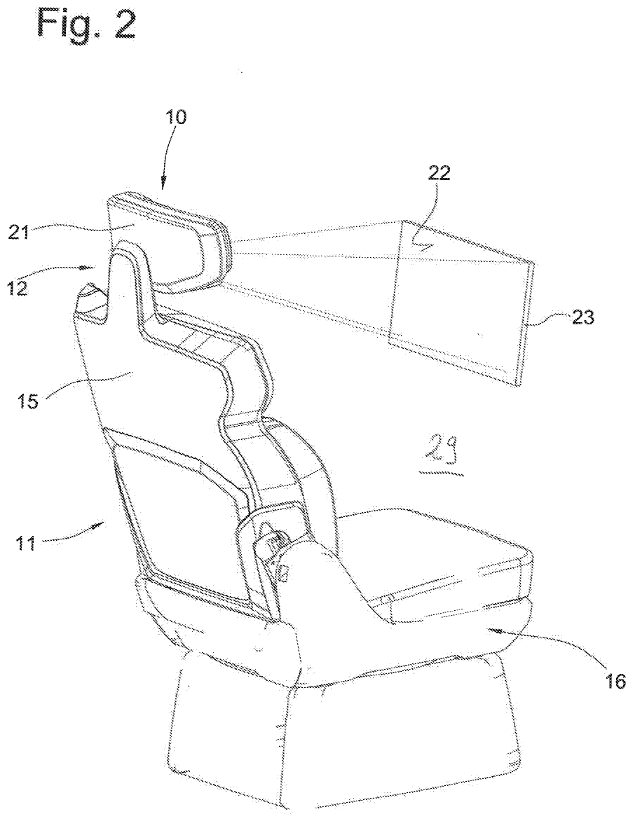

FIG. 2 is a backward perspective view of the vehicle seat according to FIG. 1,

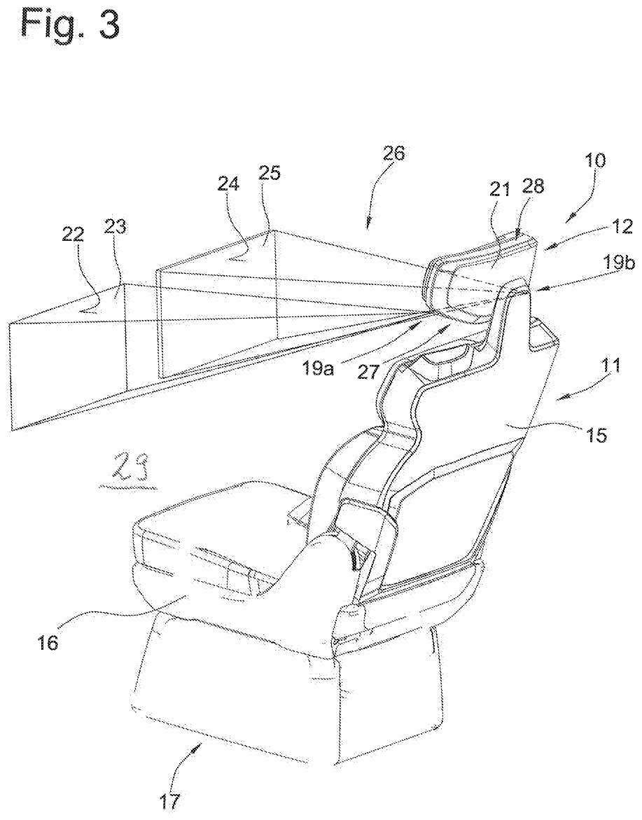

FIG. 3 shows a second embodiment that differs from the first embodiment in that the projection system has two projection walls.

The headrest system according to the invention is denoted as a whole by reference sign 10. The same reference signs in different figures denote corresponding parts, even if lower-case letters are added or omitted.

FIG. 1 shows a vehicle seat 11 comprising a seating region 16, a backrest 15 and a headrest 12, which seat is arranged in a vehicle passenger compartment 29. The headrest 12 comprises a head contact part 21 having a contact surface 14 for the head of the seat occupant. The backrest 15 has a contact surface 13. The vehicle seat 11 is fastened to the vehicle floor 18 (merely indicated in FIG. 1) by a fastening device 17, for example by an adjustable rail support.

The headrest 12 has a projection system 26 comprising projectors 19a and 19b that, in the present embodiment, each correspond to what is known as a beamer and transmit light beams. Alternatively, the projectors 19a and 19b can also emit other beams, such as laser beams.

As a result of projection openings 20a and 20b in the head contact part 21, which openings, in the present embodiment, are arranged in side regions on a lower end region 27 of the head contact part 21, the projectors 19a and 19b, which are arranged in an interior of the head contact part 21, can project light information toward the outside. Alternatively, the projection openings 20a and 20b could also be arranged at another region of the head contact part 21, e.g. higher on the side regions, or on an upper end region 28. Instead of the two projectors 20a and 20b, the projection system 26 could for example also comprise just one projector.

Light information can be projected onto a projection surface 22 of a projection wall 23 by each projector 19a and 19b. In the case of merely simple light information the projection wall can be formed for example by the vehicle window or by the dashboard. In the case of detailed light information, such as image representations, it is advantageous for the image information to be displayed on a surface that is provided especially therefor.

Alternatively, for example at least one of the projectors 19a and 19b generates a hologram, for example by a laser beam. In this case, a projection wall is not required. The image is then possible in two dimensions or three dimensions, at any desired position in space.

The projection surface can be formed so as to be stationary in the vehicle passenger compartment. Alternatively, the projection surface 22 can be provided by a projection wall 23 that, in the event of activation of the projector 19a and/or 19b, is shifted from a stowage position into a stretched position, and that then forms the projection surface 22.

In the exemplary embodiment according to FIGS. 1 and 2, the two projectors 19a and 19b project the light information thereof onto the projection surface 22. According to an alternative embodiment of the invention, the projector 19a projects the light information thereof onto a first projection surface 22, and the projector 19b projects light information, independently of the first projector 19a, onto a second projection surface 24 of a second projection wall 25 (see FIG. 3).

1. A headrest for a vehicle seat, the headrest comprising:
a head contact part that can be supported on the vehicle seat by a mount or that is formed integrally with a part of the vehicle seat,
a projection region in the vehicle offset from the head contact part, and
a projection system on the head contact part having at least one projector that can be connected to a power supply of the vehicle, and that can project a beam onto the projection region.

2. The headrest according to claim 1, wherein the projector can be oriented on the head contact part such that the light information strikes a projection surface forming the projection region of the vehicle passenger compartment.

3. The headrest according to claim 1, wherein the projector transmits a beam that generates a self-luminous hologram at the projection region in the vehicle passenger compartment.

4. The headrest according to claim 1, wherein the projection system has a controller that controls a beam state.

5. The headrest according to claim 4, in that wherein the projection system has at least one sensor that is connected to the controller for transmitting a signal thereto.

6. The headrest according to claim 1, wherein the projection system is connected to a computer, and an image generated by the computer can be displayed by the projector in the projection region.

7. The headrest according to claim 4, wherein the controller is in addition manually actuatable.

8. A headrest system comprising the headrest according to claim 1, and a projection surface of the vehicle passenger compartment forms the projection region.

9. The headrest system according to claim 8, further comprising:
a deploying device associated with the projection surface for moving the projection surface between a stowage position and a stretched position.

10. The headrest system according to either claim 8 wherein each projector is associated with a respective such projection surface.

11. The headrest system according to claim 8, wherein a plurality of the projectors are associated with one projection surface.
